(19) United States
(12) Patent Application Publication
(10) Pub. No.: US 2010/0048229 A1
(43) Pub. Date: Feb. 25, 2010

(54) METHOD FOR ACCESSING DATABASES THROUGH SMS/MMS MESSAGES

(76) Inventor: Gaetano Rizzi, Busto Arsizio (IT)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/447,301

(22) PCT Filed: Oct. 24, 2007
(86) PCT No.: PCT/IB07/03183

§ 371 Date: Jun. 15, 2009

(30) Foreign Application Priority Data
Oct. 26, 2006 (IT) TO2006A000773

(51) Int. Cl. H04W 4/12; G06F 15/16

(52) U.S. Cl. 455/466; 709/206

(57) ABSTRACT

A method for accessing a database through SMS or MMS type messages, wherein a terminal sends an SMS or MMS type request message to access a database. A processing unit, which is operationally connected to the database, receives and processes the request message and then sends an SMS or MMS type reply message to the terminal. Before the reply is sent, the method provides for verifying whether the request message includes one or more characteristic elements which, whether taken individually or as a combination, identify a previous reply message stored in a memory area of the processing unit.

The present invention relates to a method for accessing remote databases according to the preamble of claim 1.

In telecommunications systems, mobile terminals such as mobile phones, laptops, palmtops, etc.) are increasingly used for database access purposes.

As known, the latest developments of wireless technologies have made it possible to connect to local area networks (LANs), to surf the Internet or to access any kind of service available from mobile providers.

In all these cases, the connection between the remote database and the mobile terminal is maintained continuously, that is, the mobile terminal stays connected to the network all the time required for the transmission of the data searched in the remote database.

These systems, which offer the advantage that the user can keep several work sessions open simultaneously, however cause much traffic on the network since the mobile terminal must stay connected as long as required for processing the data in the database.

Other database access methods are also known which, aiming at shorter connection times and reduced band occupation, make use of text messages, e.g. SMS (Short Message System) or MMS (Multimedia Message System) messages.

Patent application US 2003/0144895 has disclosed a system for providing a consulting service. The user sends a message containing a question to be answered to a service centre.

At the service centre level, the message is processed and it is determined which experts among those registered in the central databank might be interested in answering the question. The experts thus selected are then contacted. Those who are willing to answer send a return message to the service centre, which then sends a list of available experts, with the respective charges, to the user. The user replies with a new message stating the chosen expert, after which the databank connects the user to the expert over the phone.

This system suffers from the drawback that it cannot manage further requests from the same user until the first request has been fulfilled.

It is the object of the present invention to solve the problems suffered by the known systems and access methods to remote databases.

In particular, it is the object of the present invention to provide access to databases while reducing band occupation and allowing a user, if he/she wishes, to keep a plurality of work sessions open within said databank.

This object is achieved through a method and a system incorporating the features set out in the appended claims, which are intended as an integral part of the present description.

Essentially, the idea at the basis of the present invention is to use a method for accessing a database through messages, thus reducing band occupation. In order to allow a user to keep several sessions open simultaneously, or at least to manage several requests within a short time, the method also provides for verifying if the request message includes one or more characteristic elements which, whether taken individually or as a combination, are adapted to identify univocally a reply message stored in a memory area of said processing unit.

The presence of such a reply message indicates that the analyzed request message belongs to a previously opened session univocally identified by said stored reply message. On the other hand, the absence of such a reply message indicates that the request message starts a new session, which can be either prosecuted or aborted.

Advantageously, according to the method the connection between the mobile terminal and the service centre uses a communication protocol, wherein the reply messages sent to the user by the service centre contain instructions which the service centre can decode as instructions for carrying on a session and executing corresponding actions.

These and further objects of the present invention will become more apparent from the following description and from the annexed drawings, wherein:

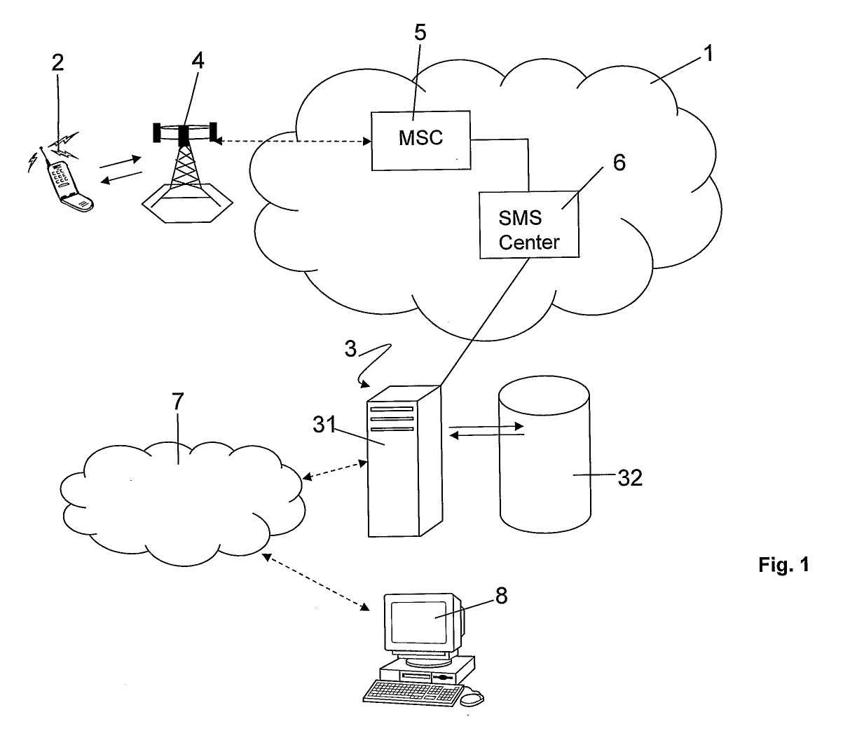

FIG. 1 shows schematically the architecture of a system according to the present invention;

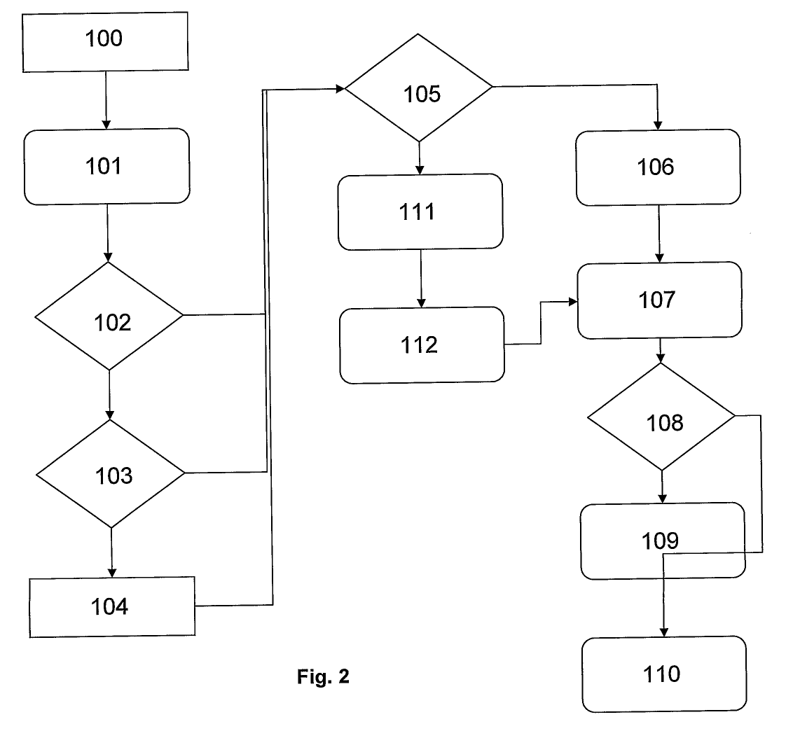

FIG. 2 is a flow chart showing a first implementation of the method according to the present invention;

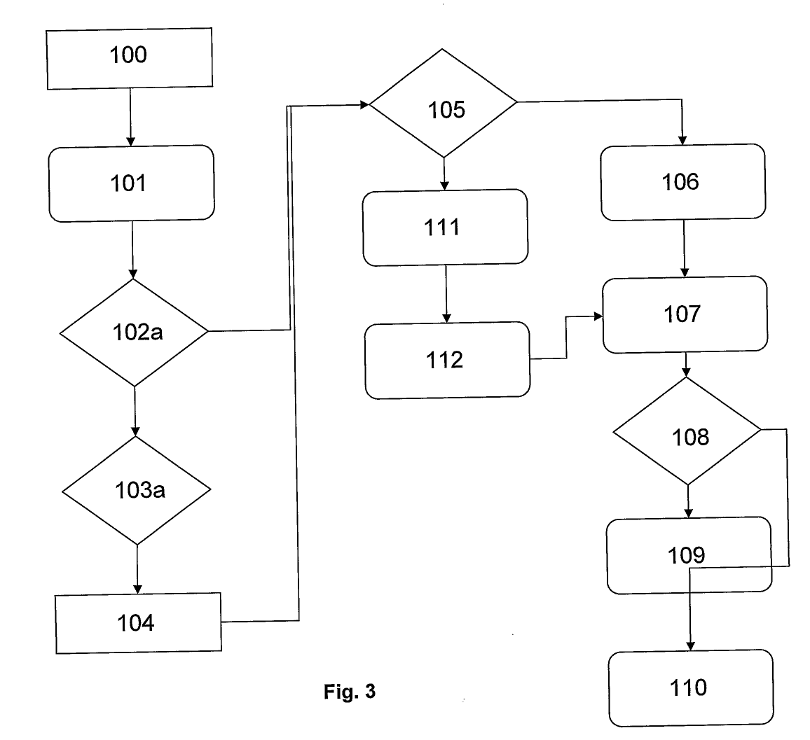

FIG. 3 is a flow chart showing a second implementation of the method according to the present invention.

FIG. 1 shows schematically the main elements involved in the method according to the present invention.

Through a mobile telephone network 1, a user 2 sends an SMS message in order to request a service offered from a service centre 3. For the purposes of the present invention, the transmission of said SMS request message corresponds to the start of a communication session between the user terminal 2 and the service centre 3.

The message, which in the present description is an SMS type text message, but may as well be another type of message (e.g. MMS), is collected by a radio base station 4 and transported in a known manner to the MSC (Mobile Switching Centre) 5 of the network. From there, the message is sent to a message centre 6, which stores it and re-sends it to the service centre 3 over either a fixed network or a mobile network. The service centre 3 receives the message and then processes it according to a method the steps of which are shown schematically in the flow chart of FIG. 2.

### EXAMPLE OF A PREFERRED EMBODIMENT

### Reception by the Service Centre

At step 100, the message is received by the service centre 3, and then (step 101) a processing unit 31 extracts the following information:
telephone number of the calling mobile terminal (e.g. 339 3829019)
text of message
geographical position of the caller

This latter piece of information may be obtained from information included in the text of the message (especially provided for by the communication protocol), or from GPS coordinates sent by the mobile terminal (which for this purpose must be fitted with a GPS device), or else be generated by the mobile telephone company that runs the network 1 (by localizing the coverage cell of the mobile terminal).

Subsequently (step 102), it is checked if there are any other open sessions for the same telephone number; this step is essentially carried out by comparing the telephone number extracted from the message with a list of telephone numbers recorded in a databank 32. These telephone numbers correspond to the users having open sessions. If no match is found during the comparison carried out at step 102, it means that this is certainly a first-level message, i.e. a message that starts a new session. In this case, the method will switch to a first-level processing step (105).

If a match is found during the comparison carried out at step 102, it will be necessary to check whether the message is a first-level one or a second-level one, i.e. a message that continues an open session not yet closed. In this case, the method will carry out a step of verifying the session to which the message belongs (step 103), so as to determine whether it must carry out a first-level (step 105) or a second-level (step 104) processing step.

### Processing the First-Level Message.

The message (step 105) is analyzed by processing unit 31, which determines whether it will be necessary, in order to reply to the message, to connect to a local database, e.g. for providing information about city hotels, or to a remote database, e.g. for making a hotel reservation, as in the example described below.

When connecting to a remote database, processing unit 31 sends a message (step 112) to a remote server 8 which manages the remote database. The communication between remote server 8 and processing unit 31 may take place through any known communication protocol.

For example, processing unit 31 may connect to remote server 8 through an IP or VPN connection (designated by reference number 7); in such a case, the IP address of the remote server may for instance be obtained from keywords extracted from the received message (step 111).

Through this connection, processing unit 31 retrieves the information required for sending a reply to the user terminal, and then will proceed from step 107 of the method as explained below.

When accessing a local database, processing unit 31 accesses the database 32 (step 106) in order to retrieve the information required for replying to the query contained in the received message.

Advantageously, as known from Italian patent application no. MI2002A002590, the reply to the received message may depend on the geographical position of the caller. Subsequently (step 107), a reply message is prepared as a reply to the message received from mobile terminal 2.

Before sending the reply message to the calling terminal, the method verifies (step 108) whether that reply message may give way to any higher-level request messages or not; for example, if information about hotels in the mountains were asked for, the reply message may contain a first list of hotels, in reply to which the user may request further information about any one of said hotels.

If no higher level is possible, then step 110 is carried out, wherein the reply message is sent; otherwise, the following characteristic elements of the reply message are stored (step 109) in a memory area called “stand-by” memory:

a) identification code (ID) of the outgoing message (automatically generated by processing unit 31 at each storage operation),
b) text of the reply message,
c) time of issue of said reply message,
d) telephone number of the user terminal which opened the session by sending the request message.

Whether they are taken individually (as in case a)) or as a combination (e.g. b) and d)), these characteristic elements are adapted to identify univocally a reply message. These elements or the entire reply messages are kept in the “stand-by” memory area for a predetermined time, e.g. one hour, which can be set at the service centre level. The verification of step 102 is carried out by comparing the telephone number of the caller (i.e. the telephone number associated with the request message) with the list of telephone numbers recorded in the “stand-by” memory area at step 108 of the method.

Once the operations for storing the characteristic elements of the reply message have been completed, the reply message is sent (step 110) to the user through a suitable gateway.

### Formatting Reply Message.

An important aspect of the present invention relates to the formatting of the reply message.

When a further interaction level with the mobile terminal is possible, e.g. to go deeper into a topic or to make a reservation for a service, the reply message is structured in such a way as to contain queries (in text format) which can be processed by the processing unit, so that the user can reply to the service centre by simply selecting one query and removing all the other ones (e.g. by deleting the corresponding text).

Within the frame of the present invention, the term “query” refers to an instruction (in text format) or to keywords used for compiling an instruction, which can be executed by a processing unit for the purpose of searching for data in a database.

As clearly explained in the following description, this communication protocol according to which all messages (whether request or reply messages) always contain information in the form of queries is particularly advantageous in that, in addition to reducing communication errors (in fact, the user does not have to re-write the query, since he/she already finds it in the reply message), a user can easily manage multiple sessions; in particular, it is advantageous in order to understand (method step 102) whether the message is a first-level or a second-level one.

### Session Verification.

Referring again to the above procedure, it is possible that, when a message is received from a user terminal 2, it is verified at the service centre level (step 102) that the “stand by” memory area contains messages previously sent by the same mobile terminal.

In this circumstance, it will be necessary to identify the session to which the message belongs, in order to know whether it is a first-level message (i.e. belonging to a new session) or a higher-level message (second, third, etc.) belonging to a previously opened session.

For this purpose, the method provides for messages of a level higher than the first contain characteristic elements of reply messages previously received by the mobile terminal and belonging to an immediately lower level. For example, a second-level request message must contain characteristic elements of the first-level reply message. Said characteristic elements may be, for example:
the message identification code (ID);
a text portion, in particular a query;
the time of issue.

At step 103, the received message (or the characteristic elements thereof) is then compared with the messages (or the characteristic elements thereof) previously received by the same terminal and still stored in the “stand-by” memory area.

If the result of this comparison shows that the received message contains one of the characteristic elements of these reply messages (which is thus determined univocally), then the received message will be treated as a higher-level message (i.e. a message belonging to the same session as that of the stored message) and will be processed as such at step 104.

If, on the contrary, the received message is a first-level message, i.e. a message that starts a new session, the method will switch to step 105, wherein a first-level message processing will take place.

Processing Messages of Level Higher than the First.

When a message is recognized as belonging to a level higher than the first, a processing step is carried out (step 104) (in addition to first-level message processing), wherein the reply message stored in the “stand-by” memory area is deleted.

Subsequently the message will be treated almost like any first-level message by executing the above-described processing steps (steps 105 to 109).

It is apparent that, whereas when processing first-level messages the processing unit must simply process the query, when processing higher-level messages the processing unit must also remember the previous interaction level. In other words, in order to be able to reply to the query the processing unit must know the status to start from. To this end, for each open session the processing unit must keep track of the status thereof, so as to be able to provide a correct interpretation of a higher-level message (and therefore of a higher-level query). This activity is preferably carried out at step 109, i.e. before the reply message is sent.

End of session.

According to the present invention, a session ends in the following cases:

a) There is no message of a higher level than the last one received by the service centre, so that the session is closed by sending the corresponding reply message. In this case, the reply message will not be stored in the “stand-by” memory area.
b) No higher-level message is received within a preset time from the time when the reply message was stored in the “stand-by” memory area. In this case, after said preset time has elapsed the reply message will be deleted from the “stand-by” memory area.

### Example of a Hotel Reservation

A user wanting to make a hotel reservation sends the following SMS message to service centre 2:
“Hotel Milano viale certosa”

The first word “Hotel” identifies the database to be accessed; this information is required when the same telephone number (e.g. 48472) is associated to several databases (Restaurants, Chemist's, Gas stations, etc.)

It follows that the word Hotel (or Hotels) is also a keyword that allows the system to refer to the appropriate database. The message thus includes the keywords (“Hotels, Milano, viale certosa”) which make up the search query.

Electronic unit 31 processes the message and recognizes that the query requires a search in local database 32 for the purpose of finding all hotels in the city of Milan. To this end, processing unit 31 carries out the search and prepares the following reply message:
“IADI—Sheraton,****,v. Manzoni24,02344755,km3-Hermitage,***,p.Duomo3,02334528,km3,9-Laguna,***,p.Genova25,02335288,km5,9”

This message contains the name, the number of stars (designated by character ‘*’), the address, the telephone number and the distance of the hotel from the geographical position of the user who sent the SMS to the service centre. This latter piece of information is available when the position of the caller is determined by the telephone company receiving the user's call and is then sent to the service centre together with the message or when it is stated in the initial query (“Hotels Milano viale certosa”).

The number of hotels included in the message depends on the number of available characters (which is different between SMS and MMS messages).

Since the user might be interested in making a reservation directly by using the system according to the present invention, the electronic unit stores the characteristic elements of the received message (which have already been described above) and sends the reply message to the user.

As the user receives the message from the service centre, if he/she wants to make a reservation at the Hermitage hotel, he/she will send a new message containing the following text:
“Hermitage,***,p.Duomo3,02334528,km3,9”

Since nowadays most mobile terminals include a message forwarding function, this last message is obtained in a very simple manner by using that function and deleting any useless queries from the message text, i.e. the useless text.

As it receives this second-level message, processing unit 31 sees that the “stand-by” memory area has already stored messages sent by the same user, and thus makes a text comparison.

Through this comparison, the processing unit finds that there is an existing message sent by the same user which includes the same query in its text. Therefore, the processing unit recognizes that it is a second-level message and thus deletes the reply message stored in the “stand-by” memory area.

Processing unit 31 also recognizes that, in order to reply to the query, it is necessary to connect to the remote server of the Hermitage Hotel, so that room availability and prices can be evaluated. Once this information has been retrieved from the server of the Hermitage Hotel, the processing unit prepares a reply message to be sent to the user, which states room availability and prices, e.g. like the following:
“Hermitage, 1 bed [symbol] 180, 2 beds [symbol] 230, suite [symbol] 500”

Since a further communication level is possible (i.e. the actual reservation of a room), the return message is recorded in the “stand-by” memory area before being sent to the user.

If the user decides to make a reservation, then he/she will send a new request message (third-level message), for example:
“Hermitage, 2 beds, 18-11-2006, 19-11-2006”

This message is processed in accordance with the above-described logics for second or higher-level messages, in order to send the reservation request to the Hermitage Hotel.

After receiving a reservation confirmation from the server of this hotel, the processing unit will send the following return message to the user:
“Hermitage, confirmation 18-11-2006, 19-11-2006, [symbol] 230”

Since no further communication level is possible, the processing unit does not store this reply message and the session is thus closed.

### Variants

The features and advantages of the present invention are apparent from the above description.

It is clear that many changes may be made to the above-described example of embodiment by those skilled in the art.

For instance, it is known that SMS and MMS messages can also be sent from fixed terminals, such as computers or telephones connected to a telephone line or a LAN. Therefore, the invention is also applicable to the case wherein the terminal sending the message is a fixed one.

A possible variant of the method also includes a step of detecting and correcting any mistake contained in the SMS request message; thus, when sending a higher-level message, if the user deletes by mistake a portion of the query contained in the reply message sent by the service centre (e.g. instead of sending the message “Hermitage,***,p.Duomo3,02334528,km3,9”, he/she sends the message “Hermitage,***,p.Duomo3,02334528,km”), the processing unit will verify, although no stored reply messages are found containing the same text, that there is much similarity, i.e. about 80-90%, between the text of the received request message and the text of the stored message, and therefore it will treat the request message as a higher-level message.

It is also clear that some steps of the above-described method may be inverted, changed or removed, so long as the method still allows a terminal to access a remote databank with multiple sessions through a message-based communication protocol. For instance, in the above-described embodiment example the comparison between the request message sent by the user terminal and the reply messages is carried out through the steps 102 and/or 103 of the method (verification of the caller's telephone number and possible comparison of texts of messages). According to a variant of the method, which is shown schematically in FIG. 3, the reply message includes an identification code (e.g. #28347). In this case, it is possible to change steps 102 and 103 by adding a step 102a, in which it is checked if the received request message contains such an identification code.

If not, the received message is a first-level one and the method will jump to step 105; otherwise, it is a higher-level message and the method will go on to step 103a, where the stored message containing the identification code included in the request message will be searched for. Once said reply message has been identified, the method will go on to the above-described step 104.

This solution offers the advantage of simplifying the comparison between the received message and the messages stored in the “stand-by” memory area, but it requires the use of a certain number of characters (which is per se rather limited, e.g. 160 for an SMS message) for the identification code.

1-13. (canceled)

14. A method for accessing a database through SMS or MMS type messages, comprising:
a terminal sending an SMS or MMS type request message to access a database; and
a processing unit, operationally connected to said database, receiving the request message, verifying if the request message includes one or more characteristic elements which, whether taken individually or as a combination, are adapted to identify a previous reply message stored in a memory area of the processing unit, and sending a first SMS or MMS type reply message to said terminal.

15. A method according to claim 14, wherein said characteristic elements are chosen among a group of characteristic elements including: a message identification code, a message text, a time of issue, a telephone number.

16. A method according to claim 14, wherein said previous reply message is deleted after a preset time.

17. A method according to claim 14, wherein said previous reply message is deleted when a match is found during said verification.

18. A method according to claim 14, wherein said first reply message contains queries which can be executed by said processing unit.

19. A method according to claim 18, wherein a second request message is sent which contains one of the queries included in said first reply message.

20. A method according to claim 14, wherein said first reply message is recorded in said memory area before it is sent to said terminal.

21. A method according to claim 20, wherein an identification code is assigned to said first reply message as it is stored.

22. A method according to claim 21, wherein said identification code is included in the text of said first reply message.

23. A method according to claim 22, wherein a second request message is sent which contains the identification code of said first reply message.

24. A method according to claim 14, wherein the content of said first reply message depends on a piece of information relating to a geographical position.

25. A session with at least two levels of interaction between a user terminal and a processing unit, wherein the user terminal starts said session by sending an SMS or MMS type message to the processing unit, which replies by sending a reply message to the user terminal, wherein the session comprises storing said reply message or elements adapted to identify it univocally.
